(19) United States
(12) Patent Application Publication
(10) Pub. No.: US 2007/0110273 A1
(43) Pub. Date: May 17, 2007

(54) Image processing method and image processing program product

(76) Inventor: Takayuki Hara, Kanagawa (JP)

Correspondence Address: DICKSTEIN SHAPIRO LLP, 1825 EYE STREET NW, Washington, DC, 20006-5403, US

(21) Appl. No.: 11/583,903

(22) Filed: Oct. 20, 2006

(30) Foreign Application Priority Data
Oct. 20, 2005 (JP) 2005-305843
Oct. 5, 2006 (JP) 2006-274018

(51) Int. Cl. G06K 9/00

(52) U.S. Cl. 382/100

(57) ABSTRACT

An information processing method is disclosed for embedding information in an image, the method including the steps of extracting a predetermined color region from the image, dividing the predetermined color region into unit regions, assigning a value included in the information to each of the unit regions, and replacing each of the unit regions with a corresponding pattern associated with the assigned value. The pattern includes at least one of the predetermined color or a color that is not included in the image.

### BACKGROUND OF THE INVENTION

1. Field of the Invention

The present invention relates to an image processing technique for embedding information in an image, and extracting the information from the image.

2. Description of the Related Art

In the field of digital watermarking and steganography, much research is being conducted for developing effective techniques for embedding information in an image and extracting the information. For example, Japanese Patent No. 3522056 discloses a technique for embedding information at a certain frequency region. According to the disclosed technique, information that is not easily perceived by the human eye may be embedded in an image such as a photograph. However, in the case of applying such a technique on a level image region (i.e., low contrast image region having little brightness variations), image quality degradation may become prominent, for example. Also, it is noted that in general, techniques employing frequency conversion requires a large calculation load, and thereby, the processing time may take longer.

In another example, Japanese Laid-Open Patent Publication No. 2004-349879 discloses an information embedding technique that involves dividing an image into blocks and changing the quantity relation between feature values (mean densities) of two blocks. Such a technique of embedding information in pixel space regions may have advantages with respect to processing time. However, block noise may be a problem in this technique as well when applied to a level image region.

Japanese Laid-Open Patent Publication No. 2004-289783 discloses an information embedding technique that involves avoiding a level image region and mainly altering black pixel outline portions of an image. However, even when employing this technique, an isolated dot may be generated within a level image region (e.g., white background) and cause image quality degradation upon attempting to embed a desired amount of information.

As can be appreciated, it has been difficult to develop a technique for embedding information in an image including a level region that can simultaneously satisfy all conditions related to embedding information amount, image quality, and processing time.

### SUMMARY OF THE INVENTION

According to an aspect of the present invention, an information processing technique is provided for effectively embedding information in an image including a level region, and effectively extracting information embedded in such an image.

According to one embodiment of the present invention, an image processing method for embedding information in an image is provided, the method including the steps of:

extracting a predetermined color region from the image;

dividing the predetermined color region into unit regions; and

assigning a value included in the information to each of the unit regions and replacing each of the unit regions with a corresponding pattern associated with the assigned value;

wherein the pattern includes the predetermined color and/or a color that is not included in the image.

In one aspect of the present embodiment, information may be suitably embedded into an image including a level region.

According to another embodiment of the present invention, an image processing method for extracting information embedded in an image is provided, the method including the steps of:

extracting a predetermined color region from the image;

dividing the predetermined color region into unit regions;

calculating for each of the unit regions a plurality of correlations with respect to a plurality of patterns associated with differing values; and

selecting a corresponding pattern for each of the unit regions based on the calculated correlations, and decoding a value assigned to each of the unit regions based on the selected corresponding pattern;

wherein the patterns include the predetermined color and/or a color not included in the image.

In one aspect of the present embodiment, information embedded in an image including a level region may be suitably extracted.

According to another embodiment of the present invention, a program for executing one or more of the image processing methods of the present invention is provided.

### BRIEF DESCRIPTION OF THE DRAWINGS

FIG. 1 is a block diagram showing an exemplary functional configuration of an information embedding/extracting apparatus according to an embodiment of the present invention;

FIG. 2 is a block diagram showing an exemplary hardware configuration of the information embedding/extracting apparatus of the present embodiment;

FIG. 3 is a flowchart illustrating an information embedding process according to a first embodiment of the present invention;

FIG. 4 is a diagram illustrating examples of information patterns used in the present embodiment;

FIG. 5 is a flowchart illustrating an information extracting process according to the first embodiment; and

FIG. 6 is a diagram illustrating a-unit region with missing pixels.

### DESCRIPTION OF THE PREFERRED EMBODIMENTS

In the following, preferred embodiments of the present invention are described with reference to the accompanying drawings.

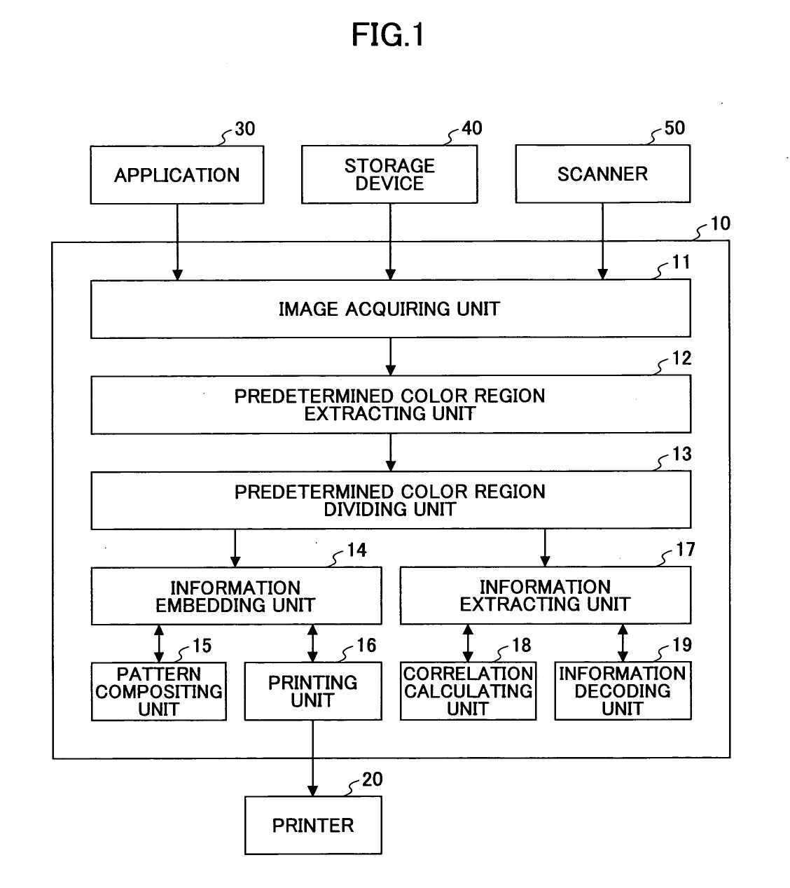

FIG. 1 is a block diagram showing an exemplary functional configuration of an information embedding/extracting apparatus according to an embodiment of the present invention. The illustrated information embedding/extracting apparatus 10 of the present embodiment is configured to embed information in an image and extract information embedded in an image. As is shown in FIG. 1, the information embedding/extracting apparatus 10 of the present embodiment includes an image acquiring unit 11, a predetermined color region extracting unit 12, a predetermined color region dividing unit 13, an information embedding unit 14, a pattern compositing unit 15, a printing unit 16, an information extracting unit 17, a correlation calculating unit 18, and an information decoding unit 19.

The image acquiring unit 11 may acquire an image from an application 30, a storage device 40, or a scanner 50, for example, and develop the acquired image on a memory. It is noted that the application 30, the storage device 40, and the scanner 50 may be built inside the information embedding/extracting apparatus 10 or provided within some other apparatus that is externally connected to the information embedding/extracting apparatus 10 by a network or a cable, for example.

The predetermined color region extracting unit 12 extracts a region of a predetermined color (referred to as “predetermined color region” hereinafter) from the image acquired by the image acquiring unit 11. The predetermined color region dividing unit 13 divides the predetermined color region extracted by the predetermined color region extracting unit 12 into plural rectangular regions (referred to as “unit region(s)” hereinafter). It is noted that the image acquiring unit 11, the predetermined color region extracting unit 12, and the predetermined color region dividing unit 13 may be used for embedding information into an image as well as extracting information that is embedded in an image.

The information embedding unit 14 controls processes for embedding information into an image using a pattern compositing unit 15 and a printing unit 16. The pattern compositing unit 15 composites a predetermined pattern representing embedded information (referred to as “information pattern(s)” hereinafter) on each unit region. It is noted that the predetermined color region dividing unit 13 divides the predetermined color region into unit regions in a manner such that the size of the unit regions may be the same as the size of the information patterns.

The printing unit 16 controls a printer 20 to print the processed image with the information patterns composited thereon that is generated by the pattern compositing unit 15. It is noted that the printer 20 may be built inside the present information embedding/extracting apparatus 10 or externally connected to the information embedding/extracting apparatus 10 via a network or a cable, for example.

The information extracting unit 17 controls processes for extracting information from an image having information embedded therein using the correlation calculating unit 18 and the information decoding unit 19. The correlation calculating unit 18 calculates the correlations between the unit regions divided by the predetermined color region dividing unit 13 and the information patterns. The information decoding unit 19 decodes the information embedded in the image based on the correlations calculated by the correlation calculating unit 18.

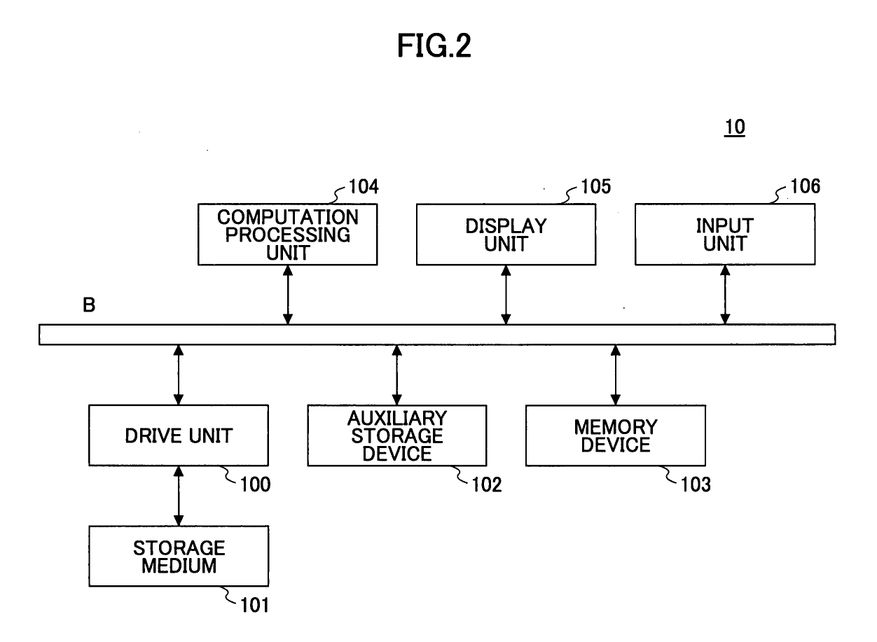

FIG. 2 is a block diagram showing an exemplary hardware configuration of the information embedding/extracting apparatus of the present embodiment. As is shown in FIG. 2, the information embedding/extracting apparatus 10 of the present embodiment includes hardware such as a drive unit 100, an auxiliary storage device 102, a memory device 103, a computation processing unit 104, a display unit 105, and an input unit 106 that are interconnected by a bus B.

It is noted that programs for executing the processes of the information embedding/extracting apparatus 10 may be stored in a storage medium 101 such as a CD-ROM. When the storage medium 101 storing such programs is set to the drive unit 100, the programs stored in the storage medium 101 may be installed in the auxiliary storage device 102 via the drive unit 100. The auxiliary storage device 102 may store the programs installed by the drive unit 100 as well as image data that are subject to processing, for example.

The memory device 103 reads and stores the programs installed in the auxiliary storage device 102 in response to the issuance of a program activation command. The computation processing unit 104 may execute functional operations of the information embedding/extracting apparatus 10 according to the programs stored in the memory device 103. The display unit 105 may display a GUI (Graphic User Interface) according to the programs stored in the memory device 103. The input unit 106 may include input devices such as a keyboard and a mouse for inputting various operation commands, for example.

It is noted that in one embodiment, the information embedding/extracting apparatus 10 may be connected to a network to be operated by another terminal stationed at a remote location. In this case, the drive unit 100, the display unit 105, and the input unit 106 do not necessarily have to be provided in the information embedding/extracting apparatus 10 and may instead be provided in the other terminal, for example.

In the following, processes performed by the information embedding/extracting apparatus 10 of the present embodiment are described.

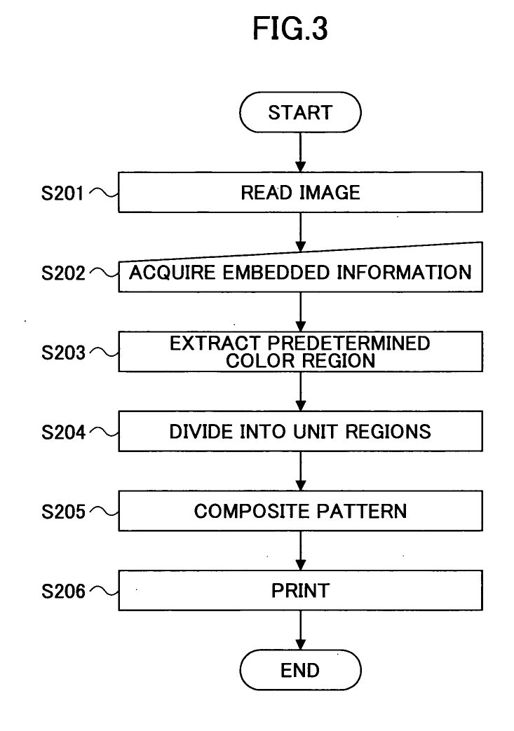

FIG. 3 is a flowchart illustrating an information embedding process according to a first embodiment of the present invention.

According to FIG. 3, the image acquiring unit 11 acquires an image that is to have information embedded therein (referred to as “subject image”) from the application 30, the storage device 40, or the scanner 50, for example, and develops the acquired image on the memory device 103 (step S201). It is noted that the information embedding process according to the first embodiment is adapted for a case in which the subject image is a monochrome image (e.g., including grayscale and binary images). In the next step (step S202), the information embedding unit 14 acquires information to be embedded into the subject image (referred to as “embedding information” hereinafter). In one example, a GUI (Graphic User Interface) or some other type of user interface may be displayed by the display unit 105 at the appropriate timing to prompt the user to input embedding information. In another example, the embedding information may be read from a file that is stored in the auxiliary storage device 102 beforehand. It is noted that in the embodiments described below, the embedding information is converted into a binary number upon being composited. However, the present invention is by not way limited to such an embodiment, and the embedding information may be composited in some other format as well.

Then, the predetermined color region extracting unit 12 extracts a predetermined color region from the subject image (step S203). It is noted that in the present embodiment, the predetermined color is assumed to be white, and accordingly, a white region is extracted as the predetermined color region. Then, the predetermined color region dividing unit 13 divides the extracted predetermined color region into unit regions (step S204). Then, the pattern compositing unit 15 assigns a bit value of the embedding information to each unit region, and replaces each unit region with a corresponding information pattern associated with the assigned bit value (step S205).

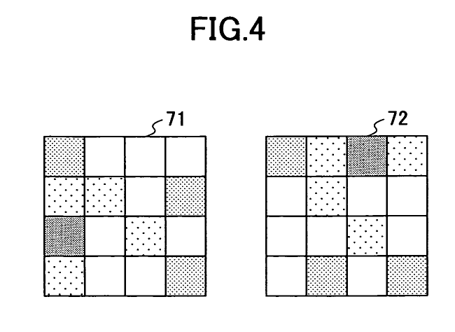

FIG. 4 is a diagram illustrating examples of information patterns. In FIG. 4, the information patterns 71 and 72, each made up of 4×4 pixels, represent the bit values 0 and 1, respectively. Accordingly, a unit region that is assigned the bit value 0 is replaced with the information pattern 71, and a unit region that is assigned the bit value 1 is replaced with the information pattern 72. It is noted that although the information pattern is not limited to a particular format, the information pattern is preferably made up of at least one of the predetermined color or a color that is not included in the subject image in order to prevent image quality degradation. In FIG. 4, monochrome multi-value patterns made up of pixels of the predetermined color (i.e., white) and non-black pixels are illustrated as the information patterns. It is noted that in the case where the predetermined color is white, the brightness value of the information pattern is preferably set high so that image quality degradation may be prevented. For example, in a case where the brightness value has a range of 0-255 to represent brightness in 256 levels (where a higher value represents a higher level of brightness), the brightness value of the information pattern is preferably at least 250. In one preferred embodiment, the brightness value of the information patterns is set to a predetermined value that represents a brightness level within the top 2% of the brightness level range.

Then, the printing unit 16 prints the subject image with the information patterns composited thereon (step S206).

In the following, a process of scanning a document generated by the process of FIG. 3 and extracting information from the document is described.

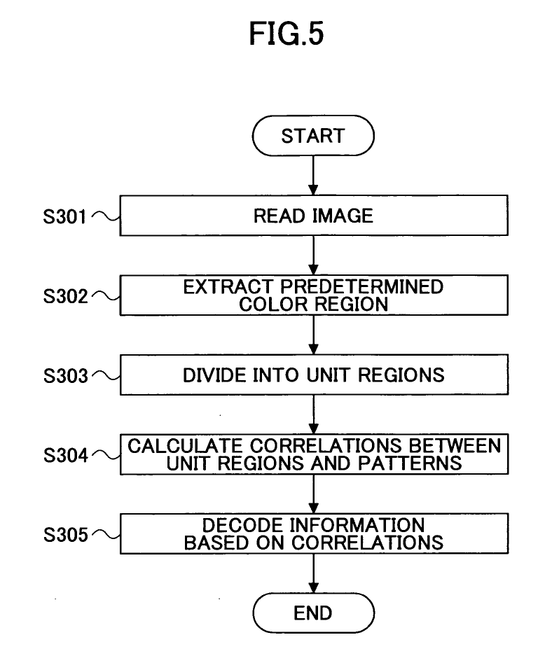

FIG. 5 is a flowchart illustrating an information extracting process according to the first embodiment.

According to FIG. 5, first, the image acquiring unit 11 develops an image of a document (referred to as “document image” hereinafter) scanned by the scanner 50 on a memory (step S301). In this case, the document image is scanned as a multi-value image. It is noted that the document scanned by the scanner 50 in the present example corresponds to the document output by the process of FIG. 3. Then, the predetermined color region extracting unit 12 extracts a predetermined color region from the document image (step S302). In the present embodiment, a region made up of pixels with brightness values of a predetermined value range (i.e., value representing white to a gray level above a predetermined level) is extracted. Then, the predetermined color region dividing unit 13 divides the extracted predetermined color region into unit regions (step S303).

Then, the correlation calculating unit 18 calculates the correlation between the unit regions and the information pattern 71 and the correlation between the unit regions and the information pattern 72 (step S304).

In one example, the correlation may be calculated based on the following formula:

$${\sum }_{i} {\sum }_{j} AijBiij$$

It is noted that in the above formula, Aij denotes the pixel value of coordinates (i, j) within a unit region, and Bij denotes the pixel value of coordinates (i, j) within the information pattern 71 or the information pattern 72.

Also, it is noted that in calculating the correlation between an information pattern and a unit region with one or more missing pixels, the pixel values for the missing pixels may be set to the average value of the pixel values of the remaining pixels within the corresponding unit region, for example.

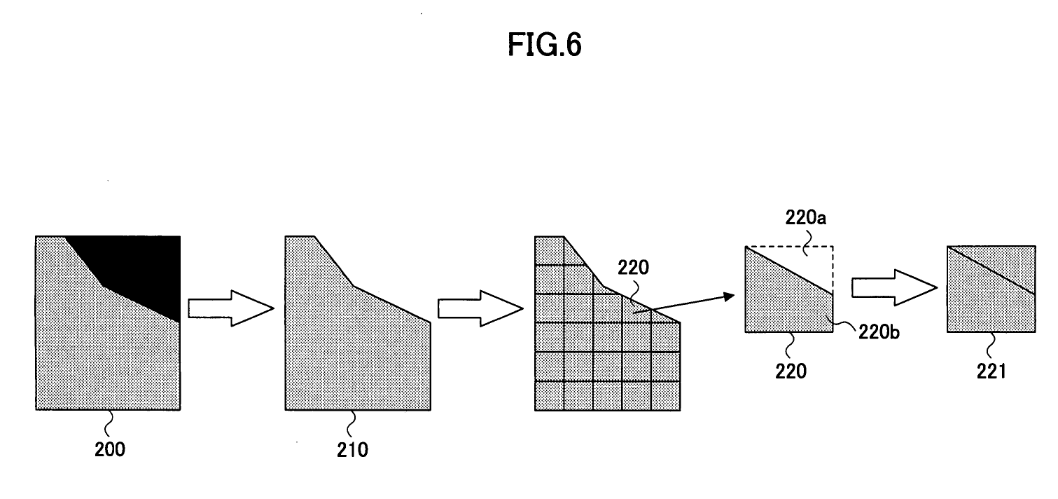

FIG. 6 is a diagram illustrating an example of a unit region having missing pixels. As is shown in this drawing, when a predetermined color region 210 is extracted from a document image 200 to be divided into unit regions, a unit region 220 having missing pixels 220a may be generated. Upon processing such a pixel 220, in one embodiment, the pixel values for the missing pixels 220a may be compensated for by the average value of the pixel values of the remaining pixels 220b of the unit region 220 (i.e., pixels other than the missing pixels) to generate a unit region 221, and the correlation between the unit region 221 and an information pattern may be calculated to determine the correlation for the unit region 220.

In another embodiment, compensation for the missing pixels may not be performed, and the missing pixels may simply be disregarded in calculating the correlation of the unit region. In this case, if the correlation is calculated based on the above formula, the pixel values of the missing pixels are assumed to be 0.

Then, the information decoding unit 19 decodes information embedded in a unit region by comparing the correlation between the unit region and the information pattern 71 and the correlation between the unit region and the information pattern 72 that are obtained from the above calculation, and determining the value (i.e., 0 or 1) associated with the information pattern having a higher correlation with the unit region as the value embedded in the unit region (step S305). It is noted that by determining the value embedded in a unit region based on the degree of correlation of the unit region with respect to the information patterns, information may be stably decoded even where there are variations in pixel values, for example.

As can be appreciated from the above descriptions, according to the first embodiment, the information embedding/extracting apparatus 10 may embed a relatively large amount of information into an image having a level region within a relatively short period of time while preventing image quality degradation of the image.

It is noted that an exemplary case of applying image processing techniques of the present invention to analog processes (processes performed through manual operations) such as printing and scanning is described as the first embodiment. However, the present invention is not limited to such an embodiment, and the image processing techniques may also be applied to other processes such as brightness correction, noise superposition, or filtering, for example.

In the following, an exemplary technique using error correction codes in information embedding/extracting processes is described as a second embodiment of the present invention. It is noted that the information embedding/extracting apparatus used in the second embodiment may have the same functional configuration and hardware configuration as the information embedding/extracting apparatus 10 used in the first embodiment.

In an information embedding process according to the second embodiment, the pattern compositing unit 15 replaces each unit region with the information pattern corresponding to the bit value of a bit array obtained by performing error correction coding on the embedding information in a process step corresponding to step S205 of FIG. 3. It is noted that other process steps of the second embodiment may be identical to those of the first embodiment.

In an information extracting process according to the second embodiment, the information decoding unit 19 decodes the error correction code using the correlations calculated by the correlation calculating unit 18 in a process step corresponding to step S305 of FIG. 5. For example, the information decoding unit 19 may decode the error correction code by determining the value (i.e., 0 or 1) assigned to each unit region according to the degree of correlation of the correlations between a unit region and the information patterns 71 and 72, or in another example, the information decoding unit 19 may perform soft decision decoding by calculating reliability (e.g., ratio or difference of correlation) from the correlations between a unit region and the information patterns 71 and 72 and decoding embedded information based on the calculated reliability.

As can be appreciated from the above descriptions, according to the second embodiment, the tolerance of embedded information with respect to image processing may be improved, and information decoding may be performed more stably.

It is noted that the error correction codes used in the present invention are not limited to a particular type of error correction codes. For example, the error correction codes may be humming codes, BCH codes, Reed Solomon codes, convolution codes, turbo codes, low-density parity codes, or any combinations of the above, for example.

In the following, a technique is described for embedding/extracting information in/from a color image as a third embodiment of the present invention. It is noted that an information embedding/extracting apparatus used in the present embodiment may have the same functional and hardware configurations as the information embedding/extracting apparatus 10 used in the first embodiment.

In an information embedding process according to the third embodiment, in a process step corresponding to step S203 of FIG. 2, the predetermined color region extracting unit 12 obtains a color histogram of a certain color of the subject image to determine the most frequently occurring color, which is designated as the predetermined color. The predetermined color region extracting unit 12 then extracts a region including the predetermined color as the predetermined color region. It is noted that in one embodiment, a region including the predetermined color as well as colors close to the predetermined color may be extracted as the predetermined color region. By designating a color that occurs most frequently in the subject image as the predetermined color, the size of the predetermined color region may be increased, and a larger amount of information may be embedded in the subject image. It is noted that the color histogram of a certain color may be calculated beforehand by clustering the relevant color and colors close to the relevant color, for example.

Also in a process step corresponding to step S205 of FIG. 3, the pattern compositing unit 15 generates two patterns made up of one or more colors included in the extracted predetermined color region as information patterns, and associates the values 0 and 1 to the information patterns. Then, the pattern compositing unit 15 assigns the bit value of embedding information to each unit region and replaces each unit region with the information pattern corresponding to the assigned bit value.

In an information extracting process according to the third embodiment, in a process step corresponding to step S302 of FIG. 5, the predetermined color region extracting unit 12 designates the most frequently occurring color in a document image as the predetermined color in a manner similar to the corresponding process step performed in the information embedding process of the present embodiment. The predetermined color region extracting unit 12 then extracts a region including the predetermined color as the predetermined color region. It is noted that in one embodiment, a region with the predetermined color as well colors close to the predetermined color may be extracted as the predetermined color region. Also, in a process step corresponding to step S304 of FIG. 5, the correlation calculating unit 18 generates two patterns made up of one or more colors included in the extracted predetermined color region in a manner similar to the corresponding process step performed in the information embedding process of the present embodiment to calculate the correlations between the unit regions and the information patterns.

As can be appreciated from the above descriptions, according to the third embodiment, the information embedding/extracting apparatus 10 may effectively embed/extract information in/from a color image. Also, by determining the predetermined color based on the color occurrence frequency, the predetermined color region may be accurately extracted even when the color changes from the time of the information embedding process to the time of the information extracting process through image processing, for example.

It is noted that the predetermined color region may be extracted in various ways. For example, pixels may be crystallized according to color space, and a region of pixels belonging to the largest cluster may be extracted as the predetermined color region. In this case, the information pattern composited according to the embedded information may be a pattern associated with this cluster. According to this method, the predetermined color region may be increased in size, and more information may be embedded in the subject image. Also, even when the color changes from the time of the information embedding process to the time of the information extracting process through image processing, the predetermined color region may be accurately extracted.

Also, it is noted that the predetermined color may be dynamically changed in the manner described above, or a color range may be designated by a system in advance. In one embodiment, the predetermined color used in the information embedding process may be stored, and the stored color may be used as the predetermined color in a corresponding information extracting process. In another embodiment, the predetermined color in the information extracting process may be determined by scanning the image with embedded information, and determining the color included in the regions from which information patterns are extracted. In this case, the image scanning operations may be stopped at the time the information patterns are extracted to improve processing speed, or the predetermined color may be extracted after searching the entire image for the information patterns, for example. Also, it is noted that the above techniques are not limited to application in the above-described embodiments.

Although the present invention is shown and described with respect to certain preferred embodiments, it is obvious that equivalents and modifications will occur to others skilled in the art upon reading and understanding the specification. The present invention includes all such equivalents and modifications, and is limited only by the scope of the claims.

The present application is based on and claims the benefit of the earlier filing date of Japanese Patent Application No. 2005-305843 filed on Oct. 20, 2005, and Japanese Patent Application No. 2006-274018 filed on Oct. 5, 2006, the entire contents of which are hereby incorporated by reference.

What is claimed is:

1. An information processing method for embedding information in an image, the method comprising the steps of:
extracting a predetermined color region from the image;
dividing the predetermined color region into a plurality of unit regions; and
assigning a value included in the information to each of the unit regions and replacing each of the unit regions with a corresponding pattern associated with the assigned value;
wherein the pattern includes at least one of the predetermined color and a color that is not included in the image.

2. The image processing method as claimed in claim 1, wherein
the step of extracting the predetermined color region involves extracting a region including a pixel that has a color component within a predetermined range.

3. The image processing method as claimed in claim 1, wherein
the predetermined color region is extracted based on an occurrence frequency of colors included in the image.

4. The image processing method as claimed in claim 1, wherein
the step of extracting the predetermined color region involves clustering colors of the image and extracting a region including a color that belongs to a largest cluster.

5. The image processing method as claimed in claim 1, wherein
a value obtained by performing error correction coding on the information is assigned to the unit regions.

6. The information processing method as claimed in claim 1, wherein
the image is a monochrome image;
the step of extracting the predetermined color region involves extracting a region including a white pixel from the image; and
the pattern is a monochrome multi-value pattern that includes a pixel of a color other than black.

7. The image processing method as claimed in claim 6, wherein
the pattern includes a pixel that has a brightness value that is greater than or equal to a predetermined value.

8. An image processing method for extracting information embedded in an image, the method comprising the steps of:
extracting a predetermined color region from the image;
dividing the predetermined color region into a plurality of unit regions;
calculating for each of the unit regions a plurality of correlations with respect to a plurality of patterns associated with differing values; and
selecting a corresponding pattern of the patterns for each of the unit regions based on the calculated correlations, and decoding a value assigned to each of the unit regions based on the selected corresponding pattern;
wherein the patterns include at least one of the predetermined color and a color not included in the image.

9. The image processing method as claimed in claim 8, wherein
the step of extracting the predetermined color region involves extracting a region including a pixel that has a color component within a predetermined range.

10. The image processing method as claimed in claim 8, wherein
the predetermined color region is extracted based on an occurrence frequency of colors included in the image.

11. The image processing method as claimed in claim 8, wherein
the step of extracting the predetermined color region involves clustering colors of the image and extracting a region including a color that belongs to a largest cluster.

12. The image processing method as claimed in claim 8, wherein
when a unit region of the unit regions has a missing pixel, the correlation calculating unit calculates the correlations of said unit region by obtaining an average value of pixel values of existing pixels of said unit region and assigning the average value to the missing pixel.

13. The information processing method as claimed in claim 8, wherein
the step of decoding the value assigned to each of the unit regions involves comparing the correlations calculated for a unit region of the unit regions and determining a pattern of the patterns having a highest correlation with said unit region, and decoding the value associated with said pattern.

14. The image processing method as claimed in claim 8, wherein
the step of decoding the value assigned to each of the unit regions involves calculating a reliability based on the correlations, and performing soft decision decoding on an error correction code.

15. A computer program product comprising a computer-readable program embodied in a computer-readable medium and including an information embedding program code for embedding information in an image, the information embedding program code being executed by a computer to perform the steps of:
extracting a predetermined color region from the image;
dividing the predetermined color region into a plurality of unit regions; and
assigning a value included in the information to each of the unit regions and replacing each of the unit regions with a corresponding pattern associated with the assigned value;
wherein the corresponding pattern includes at least one of the predetermined color and a color that is not included in the image.

16. The computer program product as claimed in claim 15, wherein the computer-readable program further includes an information extracting program code for extracting the information embedded by the information embedding program code from a corresponding processed image, the information extracting program code being executed by the computer to perform the steps of:
extracting a corresponding predetermined color region from the corresponding processed image;
dividing the corresponding predetermined color region into a plurality of corresponding unit regions;
calculating for each of the corresponding unit regions a plurality of correlations with respect to a plurality of patterns associated with differing values; and
selecting the corresponding pattern for each of the corresponding unit regions based on the calculated correlations, and decoding the value assigned to each of the unit regions based on the selected corresponding pattern.
